(19) United States
(12) Patent Application Publication
(10) Pub. No.: US 2015/0130577 A1
(43) Pub. Date: May 14, 2015

(54) INSULATION PLANAR INDUCTIVE DEVICE AND METHODS OF MANUFACTURE AND USE

(71) Applicant: Pulse Electronics, Inc., San Diego, CA (US)

(72) Inventors: Ma Hongzhong, San Diego, CA (US); Li Huatu, San Diego, CA (US)

(21) Appl. No.: 14/476,612

(22) Filed: Sep. 3, 2014

Related U.S. Application Data
(60) Provisional application No. 61/876,125, filed on Sep. 10, 2013.

(51) Int. Cl. H01F 27/28; H01F 41/06; H01F 27/34; H01F 41/32; H01F 27/29; H01F 27/32

(52) U.S. Cl. CPC H01F 27/2823; H01F 27/29; H01F 27/323; H01F 27/346; H01F 41/32; H01F 41/0612
USPC 336/192; 29/606; 29/605

(57) ABSTRACT

A low cost, high performance electronic device for use in electronic circuits and methods. In one exemplary embodiment, the device includes an interleaved flat coil and coil winding arrangement that ensures low leakage inductance while using a combination of flat coil windings and self-bonded Litz coil windings. The flat coil windings further include features that are configured to mate with the header assembly terminal pins which substantially simplify the manufacturing process. Methods for using and manufacturing the aforementioned inductive devices are also disclosed.

### PRIORITY

This application claims the benefit of priority to co-owned U.S. Provisional Patent Application Ser. No. 61/876,125 of the same title filed Sep. 10, 2013, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates generally to circuit elements, and more particularly in one exemplary aspect to inductive devices for use in e.g., power transformer or other applications, and methods of utilizing and manufacturing the same.

2. Description of Related Technology

A myriad of different configurations of inductive electronic devices are known in the prior art. Many traditional inductive components, such as transformers, utilize primary and secondary windings made from conductors which are insulated from one another. The voltage applied to the primary winding dictates the voltage generated in the secondary winding based on the wire turn ratio between the primary and secondary windings.

However, due to inter alia, ever-increasing needs for reductions in component size and cost of manufacturing, so-called planar inductive devices that utilize printed circuit board (PCB) technology have become popular design implementations for forming inductive devices such as transformers. One such example of a prior art flat coil planar transformer is illustrated in FIGS. 1A and 1B. The flat coil planar transformer 100 of FIGS. 1A and 1B is typically used in power supply applications or other circuits that require current isolation. The flat coil planar transformer of FIGS. 1A and 1B comprises a plurality of wound flat coils 106 that are disposed directly within a planar core formed of lower 104 and upper core elements 102. The flat coil windings are stacked in a vertical alignment forming an alternating primary-secondary coil arrangement, one atop the other. The flat coils are also configured to contain terminal apertures that are formed to mate to corresponding post pins resident on the header assembly 108. The core elements are formed from a magnetically permeable material, such as ferrite, with the flat coil windings sandwiched there between.

While the device in FIGS. 1A and 1B has been recognized by the industry as adequate in performing its respective mechanical and electrical functions, the device in FIGS. 1A and 1B is relatively expensive to manufacture, due at least in part to the number of flat coil windings required (e.g., six (6)) for adequate interleaving, in order to reduce the leakage inductance for the device. As is well known, leakage inductance is a property of an electrical transformer in which the windings appear to have some inductance in series with the mutually-coupled transformer windings. This is due in part to imperfect coupling of the windings within the transformer.

However, the stacked arrangement shown in FIGS. 1A and 1B also exhibits an inability to achieve the required safety distance for high potential voltage situations. In order to address, inter alia, the safety distances required in high voltage applications a new construction methodology will now be required.

Accordingly, there remains a salient need for inductive devices that are less costly and easier to manufacture, while addressing known issues related to high voltage applications, such new devices being enabled by, inter alia, addressing the difficulties associated with the stacking of the flat coil windings as is known in the prior art. Ideally, such new devices will meet the high level of insulation required while achieving a lower direct current resistance (DCR) for high current applications while also achieving a low leakage inductance.

### SUMMARY

In a first aspect, an inductive device is disclosed. In one embodiment, the device includes: a header assembly comprising a plurality of terminals; at least one core; and an interleaved flat coil winding arrangement comprising two or more flat coil windings, disposed in proximity to the at least one core and electrically coupled with respective ones of the terminals; and an interleaved self-bonded coil winding arrangement.

In a second aspect, a header is disclosed. In one embodiment, the header includes increased creepage spacing for the interleaved self-bonded coil winding arrangement.

In a third aspect, an interleaved flat coil arrangement winding for use in the aforementioned inductive device is disclosed. In a fourth aspect, a method of manufacturing the aforementioned inductive device is disclosed. In one embodiment, the method of manufacturing the aforementioned inductive device includes: providing a header assembly; providing one or more core elements; providing a plurality of flat coil windings; providing a plurality of self-bondable coil windings; and assembling the plurality of flat coil windings, the plurality of self-bondable coil windings, and the one or more core elements to the header assembly.

### BRIEF DESCRIPTION OF THE DRAWINGS

The features, objectives, and advantages of the disclosure will become more apparent from the detailed description set forth below when taken in conjunction with the drawings, wherein:

FIGS. 1A and 1B are a perspective view and an exploded perspective view of a prior art planar flat coil transformer.

FIG. 2 is an exploded perspective view of an inductive device in accordance with one embodiment of the present disclosure.

FIG. 3 is a top plan view of the inductive device illustrated in FIG. 2 in accordance with one embodiment of the present disclosure.

FIG. 4 is a flow chart diagram illustrating an exemplary method of manufacture in accordance with one embodiment of the present disclosure.

All Figures disclosed herein are © CD Copyright 2013 Pulse Electronics, Inc. All rights reserved.

### DETAILED DESCRIPTION

Reference is now made to the drawings wherein like numerals refer to like parts throughout.

As used herein, the terms “bobbin”, “form” (or “former”) and “winding post” are used without limitation to refer to any structure or component(s) external to the windings themselves that are disposed on or within or as part of an inductive device which helps form or maintain one or more windings of the device.

As used herein, the terms “electrical component” and “electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein, the term “inductive device” refers to any device using or implementing induction including, without limitation, inductors, transformers, and inductive reactors (or “choke coils”).

As used herein, the term “signal conditioning” or “conditioning” shall be understood to include, but not be limited to, signal voltage transformation, filtering and noise mitigation, signal splitting, impedance control and correction, current limiting, capacitance control, and time delay.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

### Overview

The present disclosure provides, inter alia, an improved inductive device, and methods for manufacturing and utilizing the same. Embodiments of the improved inductive device described herein are adapted to overcome the disabilities of the prior art by providing a “planar” inductive structure with improved creepage distance and coil windings in order to meet basic and/or reinforced insulation requirements. Embodiments of such an improved inductive device are enabled via the use of a self-bondable Litz wire coil winding in combination with traditional flat coil windings. These flat coil and self-bondable coil windings can also be arranged in an interleaved coil winding arrangement that eliminates the stacked vertical arrangement found in the prior art. Specifically, embodiments of the present disclosure use these self-bondable coil windings in a manner that is lower in cost, increases design flexibility, while also meeting high level insulation requirements such as basic or reinforced insulation. Additionally, the flat coil windings achieve lower direct current resistance (DCR) for high current applications and support a high level of interleave to achieve a lower leakage inductance than what is currently seen with traditional planar inductors.

Exemplary embodiments of the device are also adapted for ready use by automated packaging equipment such as e.g., pick-and-place equipment and other similar automated manufacturing devices.

Embodiments of the disclosure also advantageously provide a high level of consistency and reliability of performance by limiting opportunities for errors or other imperfections during the manufacture of the device.

Inductive devices of the present disclosure are also suitable for use in, inter alia, push pull transformers as well as DC to DC forward/half-bridge and full-bridge topologies.

### Detailed Description of Exemplary Embodiments

Detailed descriptions of the various embodiments and variants of the apparatus and methods of the disclosure are now provided. While primarily discussed in the context of inductive devices used in e.g., power transformer applications, the various apparatus and methodologies discussed herein are not so limited. In fact, many of the apparatus and methodologies described herein are useful in any number of electronic or signal conditioning components that can benefit from the simplified manufacturing methodologies described herein.

In addition, it is further appreciated that certain features discussed with respect to specific embodiments can, in many instances, be readily adapted for use in one or more other contemplated embodiments that are described herein. It would be readily recognized by one of ordinary skill, given the present disclosure that many of the features described herein possess broader utility outside of the specific examples and implementations with which they are described.

### Inductive Device—

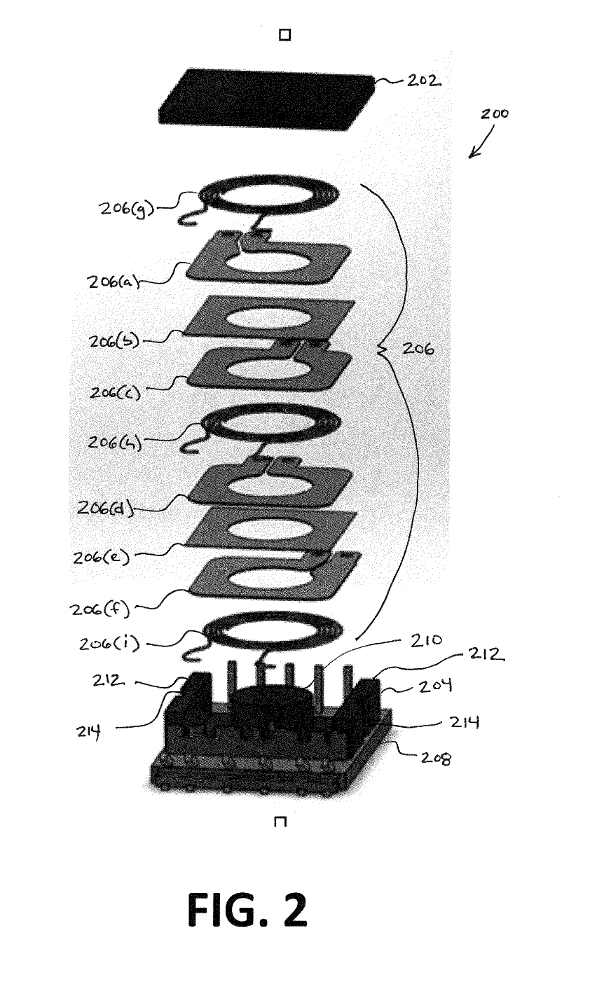

Referring now to FIG. 2, a first exemplary embodiment of an inductive device 200 in accordance with the principles of the present disclosure is shown and described in detail. The inductive device as illustrated includes an upper core element 202 and a lower core element 204, an interleaved flat coil and coil winding arrangement 206, and a header assembly 208. The interleaved flat coil and coil winding arrangement 206 is preferably formed prior to being received on the center post 210 of the lower core element 204. It will be appreciated that as used herein, the term “flat” includes windings and other components which have at least one substantially planar side, and the term in no way connotes any particular thickness or height.

The lower core element 204 as illustrated includes a flat bottom surface, while the opposing interior surface includes two riser elements 212 and a cylindrical center post element 210 that protrudes from the geometric center of the lower core element. The riser elements are located at opposing edges and run the entire width of the lower core element. The center post element is configured to have the same height as the riser elements; however it is also envisioned that in certain embodiments, it may be desirable to include a reduced height for the center post thereby creating a gap between the upper 202 and lower core element 204 that allows for adjustment of the inductive characteristics of the inductive device. The lower core element also, in the illustrated embodiment, includes alignment features 214 that are configured to mate with respective standoff elements (not shown) present on the header assembly. The upper core element 202, in the illustrated embodiment, is configured with flat external surfaces. The length and width dimensions of the upper core element are sized so as to generally match the respective dimensions of the lower core element.

While a specific exemplary core configuration is illustrated in FIG. 2, it is appreciated that the present disclosure described herein is not so limited. For example, the upper and lower core element configurations could be swapped such that the lower core element is now the upper core while the upper core element becomes the lower core. In addition, while a cylindrical center post element 210 is illustrated as exemplary, it is appreciated that this center post element can be shaped to accommodate any number of differing configurations. For example, the center post can comprise an elongated cylindrical post such as those described in co-owned U.S. Provisional Patent Application Ser. No. 61/650,395 filed May 22, 2012 and entitled “Substrate-Based Inductive Devices and Methods of Using and Manufacturing the Same”, the contents of which are incorporated herein by reference in its entirety, could also be readily substituted in alternative embodiments. Additionally, further core configurations, such as those described in co-owned U.S. Pat. No. 7,994,891 filed Oct. 1, 2009 and entitled “Stacked Inductive Device Assemblies and Methods”, the contents of which are incorporated herein by reference in its entirety, could also be readily substituted in alternative embodiments. Additionally, while illustrated as comprising a single cylindrical center post element, it is appreciated that two or more center post elements are envisioned in specific inductive device implementations.

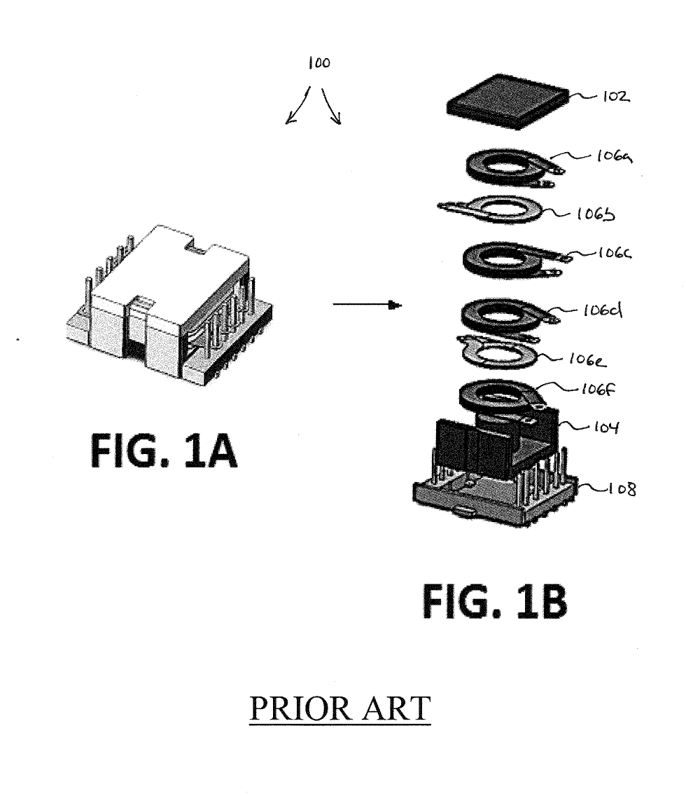

The inductive device 200, as discussed previously herein, further includes an interleaved flat coil arrangement 206 comprising four (4) flat coil windings 206(a), 206(c), 206(d), and 206(f). While the use of four (4) flat coil windings is exemplary, it is appreciated that more or less flat coil windings could readily be substituted in alternative configurations. The use of four (4) flat coil windings is merely illustrated to demonstrate the efficacy of using the interleaved arrangement over a similar flat coil winding as is present in the embodiment illustrated with respect to FIGS. 1A and 1B. The flat coil windings in this illustrated embodiment are formed from a metallic flat wire stock that is either: (1) punched from the underlying base material; or (2) wound onto a mandrel, and subsequently coated with a nonconductive material to provide electrical isolation between adjacent layers when formed into a coil such as that described in co-owned and co-pending U.S. Provisional Patent Application Ser. No. 61/810,654 filed Apr. 10, 2013 and entitled “Interleaved Planar Inductive Device and Methods of Manufacture and Use” and co-owned and co-pending U.S. patent application Ser. No. 13/802,033 filed Mar. 13, 2013 and entitled “Flat Coil Planar Transformer and Methods”, the contents of each of the foregoing being incorporated herein by reference in their entirety. In addition, one such exemplary method for providing electrical isolation for the flat coil windings is the use of a parylene coating such as that disclosed in co-owned U.S. Pat. No. 6,642,827 issued on Nov. 4, 2003 and entitled “Advanced Electronic Microminiature Coil and Method of Manufacturing”, the contents of which are incorporated herein by reference in their entirety. When formed by winding onto a mandrel, the flat coil windings are formed into a compressed spiral loop where the number of loops is associated with the number of turns for the inductive device. The loop diameter for the flat coil winding is also variable although, in the illustrated embodiment, chosen so as to be of a sufficient size in order to accommodate the center post of the lower core element.

The inductive device 200 of FIG. 2 includes, in addition to the four (4) flat coil windings, three (3) coiled windings 206(g), 206(h), and 206(i) as well as two insulating layers 206(b), 206(e) that increases the insulation between adjacent flat coil windings. The three (3) coiled windings comprise, in an exemplary implementation, a specialized self-bonding insulation litz wire which can be utilized as primary windings in the illustrated embodiment to achieve the safety distance necessary in many high voltage implementations. This self-bonding insulation litz wire is, in an exemplary embodiment, coated with a perfluoroalkoxy (PFA) jacket that includes a single layer of insulation (to meet basic insulation requirements); or alternatively with double or triple layers of insulation to meet reinforced insulation requirements. Advantages of using this litz wire is that it is lower in cost (as compared with the flat coil windings illustrated supra) while offering increased design flexibility and high level insulation requirements. Litz wire is a type of cable used in electronics comprising a plurality of strands of conductive wires that is configured to carry current while simultaneously reducing the skin effect and proximity effect losses in single stranded conductors used at frequencies up to about 1 MHz. This Litz wire consists of many thin wire strands, individually insulated and twisted or woven together. Examples of woven wire strands are described in co-owned U.S. Pat. No. 8,405,481 issued on Mar. 26, 2013 and entitled “Woven Wire, Inductive Devices, and Methods of Manufacturing”, the contents of which are incorporated herein by reference in its entirety.

These individual strands are constructed by adding an adhesive coating to existing PFA plastic jacket coated Litz wire in order to make it self-bondable during the winding operation and thus allowing the wire to be wound turn over turn in a single layer of wire with a PFA protective jacket. This adhesive coating is heated, after the Litz wire has been wound, such that two or more turns of windings are bonded into a single structure. This specialized Litz wire provides both basic and reinforced insulation in a compact multi-winding format that can be used as, for example, stand-alone coils for resonant transformers used in wireless charging stations. The use of Litz wire in devices such as planar transformers has many advantages such as, reduced height, lower leakage inductance, and lower cost over conventional flat coil planar transformers (such as those shown in FIGS. 1A and 1B).

While the specific number of turns for the flat coil and coil windings shown is exemplary, it is appreciated that the associated windings and turns ratios could be readily varied in accordance with the principles of the present disclosure. In addition to varying the number of discrete: (1) flat coil; and (2) coil windings; the number of turns within a given winding; and the size of the windings can also be varied. For example, the primary winding could be constructed from an exemplary litz wire winding having a given wire gauge and thickness associated with that primary winding, while the secondary winding (i.e. flat coil winding) might have a comparable thickness as the primary winding but have a differing width. Such a configuration might, for example, vary the capacitive characteristics of the underlying inductive device by varying the amount of overlap between a given primary winding and a given secondary winding. Additionally, the thicknesses of the primary and secondary windings may vary in some embodiments, while the respective widths may either be the same or vary. By varying the thicknesses of the flat coil and coil windings, the amount of current that a given winding can handle will also vary accordingly.

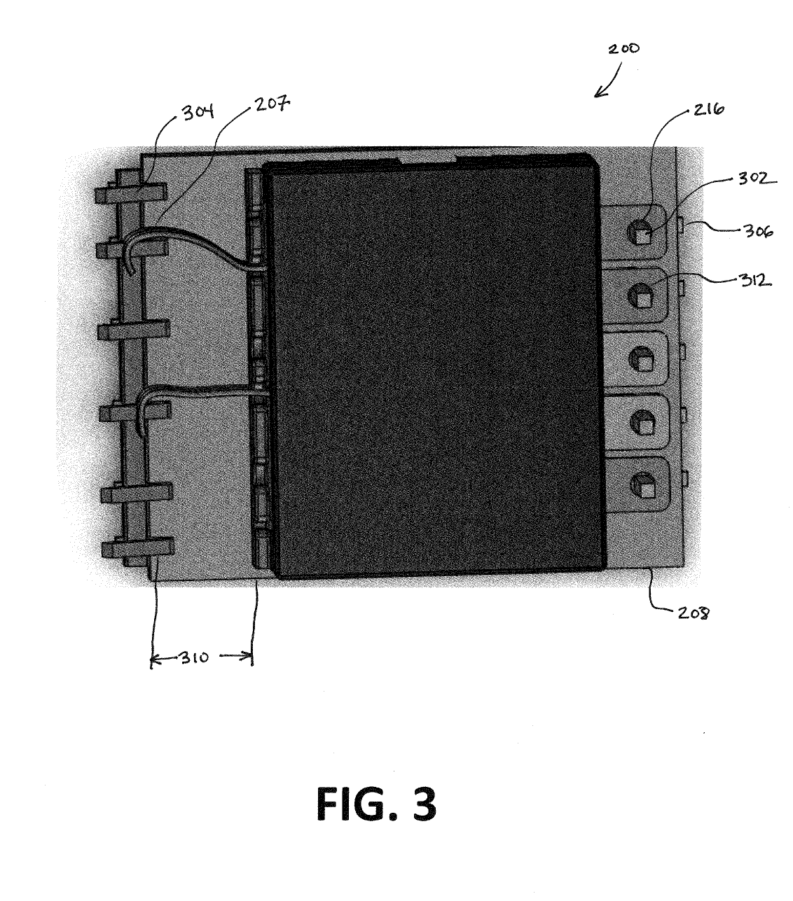

Referring now to FIG. 3, an exemplary embodiment of the header assembly 200 for use with the inductive device of, for example, FIG. 2 is shown and described in detail. The header body 208 is preferably formed from an injection molded polymer. The header body in the illustrated embodiment includes a center cavity designed to accommodate the lower core element. By sizing the center cavity to a dimension slightly larger than the lower core element, the lower core element is properly positioned within the header assembly so as to facilitate the self-alignment of the interleaved flat coil arrangement with the terminal pins 302, 304.

The terminal pins 302, 304 are, in an exemplary embodiment, constructed from a copper-based alloy material that is useful for solder processes compliant with the restriction of hazardous substances directive (RoHS). The terminal pins are, in an exemplary embodiment, insert-molded into the header body. While insert molded terminals are exemplary, post inserting processes (i.e. after molding process) can also be readily utilized if desired. The terminal pins 302 are positioned so that they protrude vertically from the header body 208. These terminals pins 302 are also sized so as to mate with respective terminal apertures 216 present on the flat coil arrangement. The terminals also include, in an exemplary embodiment, a tapered end (not shown) that facilitates insertion of the flat coil windings onto the terminals. The bottom 306 of the vertical terminal pins 302 are also formed at an approximate 90-degree angle to create a surface mount terminal, although other interfaces for the terminal pins, such as through hole terminals, could be readily substituted if desired. While illustrated as including gull-wing surface mount terminals, it is appreciated that other alternative arrangements could also be accommodated. For example, the terminals can include spool head surface mount terminals which are configured for surface mounting the inductive device to a printed circuit board without increasing the overall footprint of the inductive device. Furthermore, it will be appreciated that the header assembly may comprise a self-leaded arrangement (not shown) of the type described in co-owned U.S. Pat. No. 5,212,345 to Gutierrez issued May 18, 1993 entitled “Self leaded surface mounted coplanar header”, or U.S. Pat. No. 5,309,130 to Lint issued May 3, 1994 and entitled “Self leaded surface mount coil lead form”, both of which are incorporated herein by reference in their entirety. These and other embodiments would be readily apparent to one of ordinary skill given the present disclosure.

Referring now to the opposite terminal pins 304, these terminal pins protrude at an approximate 45° angle from the surface of the header body 208. The coil winding terminal ends 207 protrude from the upper and lower core elements and are wrapped around associated terminal pins 304. The flat coil and coil windings and their respective terminal pins 302, 304 are subsequently bonded using soldering or other bonding methods (e.g. resistance welding, etc.). In addition, the ends 207 of the Litz coil winding are spaced at a distance 310 that can vary the creepage distance of the winding to meet basic and are reinforced insulation requirements.

In addition to the addition of the creepage distance 310 for the exemplary Litz coil windings, the terminal connections 312 of the flat coil windings may reside at varying levels of the terminal pins 302. Such a configuration is advantageous as the distance between adjacent terminal connections can be maximized to increase the device's resistance to high voltage potentials that can cause, inter alia, arcing/shorting between adjacent terminal pins 302. Such a configuration for varying the height levels of the terminal connections is described in co-owned and co-pending U.S. patent application Ser. No. 13/802,033 filed Mar. 13, 2013 and entitled “Flat Coil Planar Transformer and Methods”, the contents of which were previously incorporated herein by reference in its entirety.

### Exemplary Inductive Device Applications—

The exemplary inductive devices described herein can be utilized in any number of different operational applications. For example, configurations of the inductive devices described herein can be utilized in push pull transformers (a type of DC-to-DC converter) that acts as a switching converter to change the voltage of a direct current (DC) power supply. This is accomplished by having the primary (e.g., Litz wire winding) supplied with current from the input line by pairs of transistors in a symmetrical push-pull circuit. The transistors are alternately switched on an off, periodically reversing the flow of current in the transformer device. Accordingly, current is drawn from the line during both halves of the switching cycle. Use of these exemplary inductive devices in push pull topologies are suitable for use in, for example, battery source applications in the military/aerospace and automotive industries.

In addition to push-pull power transformers with, for example, a single primary winding and one or more secondary windings, other possible electrical applications for the inductive devices described herein include, without limitation, isolation transformers, inductors, common-mode chokes, and switch-mode power transformers used, inter alia, in power supply applications. Moreover, the exemplary inductive devices described herein are suitable for use in direct current (DC) to DC forward/half-bridge and DC to DC full-bridge topologies. These and other inductive device applications would be readily apparent to one of ordinary skill given the present disclosure.

### Methods of Manufacture—

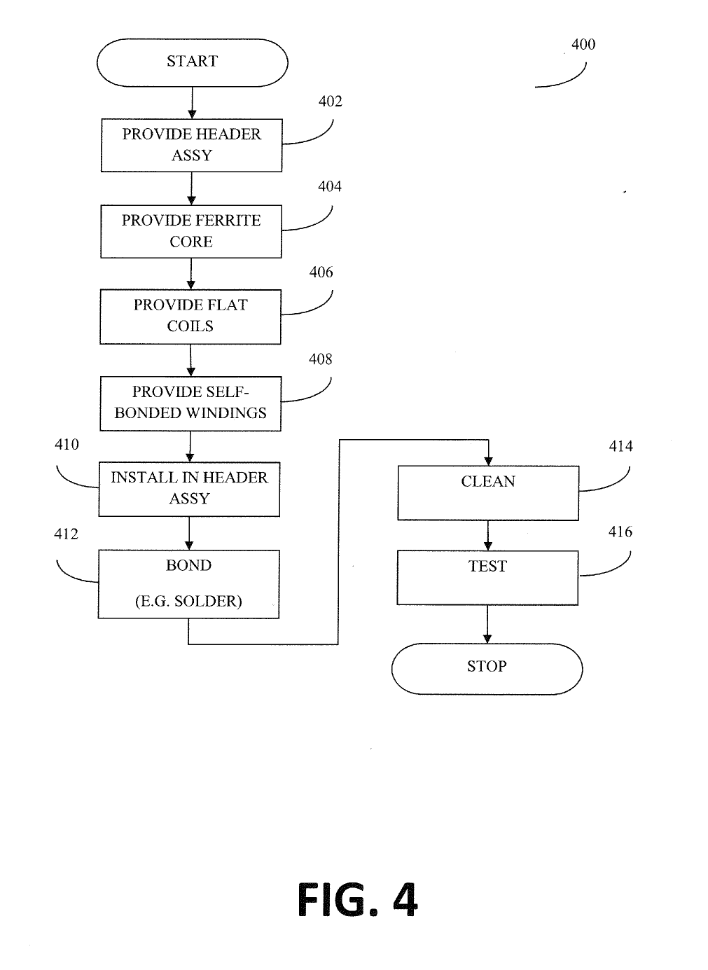

Referring now to FIG. 4, an exemplary embodiment of a method 400 for manufacturing the inductive device of, for example, FIGS. 2-3 are now described in detail. It will be recognized that while the following description is cast in terms of the inductive device 200 of FIGS. 2-3, the method is generally applicable to the various other configurations and embodiments of devices disclosed herein with proper adaptation, such adaptation being readily accomplished by one of ordinary skill when provided the present disclosure.

At step 402, a header assembly is provided. The header assemblies may be obtained by e.g., purchasing them from an external entity, or they can be indigenously fabricated by the assembler, or combinations of the foregoing. The exemplary header assembly is, as was previously discussed, manufactured using a standard injection molding process of the type well understood in the polymer arts, although other constructions and processes may be used. In addition, the header assembly will contain post pin terminals with the bottom of the pin terminals preferably formed to provide for a surface mount connection, although other types of surface mount or other mounting approaches may be used (e.g., through-hole terminals, etc.).

At step 404, one or more core elements are provided. The upper core elements described herein may be, e.g., obtained by purchase from an external entity, or alternatively, fabricated in-house. Lower core elements are also obtained by purchase from an external entity or fabricated. The core components of the exemplary inductive device described above is, in an exemplary embodiment, formed from a magnetically permeable material (e.g., so-called “soft” iron, laminated silicon steel, carbonyl iron, iron powders and/or ferrite ceramics) using any number of well understood manufacturing processes such as pressing or sintering. Exemplary embodiments of the core elements described herein are produced to have various material-dependent magnetic flux properties, cross-sectional shapes, riser dimensions, gaps, etc.

At step 406, the flat coil windings are provided. In one embodiment, the flat coil windings are formed onto a mandrel, and subsequently insulated using well known processes such as parylene coating vapor deposition. The flat coils can either be formed individually or in the alternative formed with multiple flat coils formed simultaneously. The flat coils are preferably formed from a copper-based alloy flat wire; although other types of conductive materials such as nickel-iron alloys (e.g., Alloy 42) may be readily substituted. After forming, the terminal apertures, intended to mate with their respective post pins on the header assembly, and optional notches are stamped into the flat coil windings. Alternatively, the terminal apertures and notches are stamped into the flat coil windings prior to being disposed and formed onto a mandrel.

At step 408, the self-bondable coil windings are provided. In an exemplary embodiment, a self-bondable Litz wire is wound into a single layer around a winding mandrel. The Litz wire is then heated thereby forming a unitary wound structure.

At step 410, the assembled core and interleaved flat coil and coil assembly are placed onto the header assembly. In one embodiment, the interleaved flat coil and coil assembly is placed within the interior cavity of the header assembly such that the assembly is resting upon internal standoff features (not shown) that are present within the header assembly of, for example, FIG. 3. The core assembly is then optionally secured to the header assembly using an adhesive or secured via a mechanical fit such as via a press fit or snap feature. During installation the terminal apertures of the flat coil windings are arranged such that they mate with the respective terminal pins of the header assembly while the Litz wire ends of the coil windings are secured to respective terminals pins via wire wrapping and soldering.

In an alternative arrangement, the lower core is first secured to the header assembly using, for example, an epoxy adhesive. The interleaved flat coil and coil assembly is then placed onto the bottom core and arranged such that the terminal apertures are received onto the terminals and the Litz wire ends are wrapped around respective ones of the terminals located on the header assembly 200. The upper core element is then subsequently bonded to the lower core element using an epoxy adhesive. One or more of a face-to-face bond or bridge bond is then used to secure the upper and lower core elements to one another.

At step 412, the header assembly terminal pins and interleaved flat coil and coil arrangement of the subassembly are bonded. In one embodiment, the bonding is performed using a standard eutectic solder. In an alternative embodiment, a conductive epoxy can be utilized at the terminal apertures of the flat coil windings thereby forming a mechanical and electrical connection with the terminal pins of the header assembly. In yet another alternative, the arrangement is secured to the terminal pins via a welding technique (e.g. resistance welding).

At steps 414 and 416, the headers are optionally cleaned (e.g., for 2-5 minutes in either de-ionized water or isopropyl alcohol or another solvent), such as by using an ultrasonic cleaning machine in order to remove chemicals and contaminants that can, for example cause degradation of the underlying inductive device. The inductive device is then marked (including product number and manufacturing code), tested if desired and subsequently re-worked, if necessary, to correct any manufacturing defects that may be present. The inductive devices are then subsequently packaged for shipment, preferably in packaging that facilitates automated handling (e.g. tape and reel carriers and the like).

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. An inductive device, comprising:
a header assembly comprising a plurality of terminals;
at least one core;
a plurality of flat coil windings arranged in an interleaved form and disposed in proximity to the at least one core and electrically coupled with respective ones of the plurality of terminals; and
a plurality of self-bondable coil windings arranged in an interleaved form and disposed in proximity to the at least one core and electrically coupled with respective ones of the plurality of terminals.

2. The inductive device of claim 1, wherein the at least one core comprise an upper core element and a lower core element.

3. The inductive device of claim 2, wherein the lower core element further comprises a plurality of riser elements and a center post element that protrudes from the geometric center of the lower core element.

4. The inductive device of claim 3, wherein the plurality of riser elements are located on opposing edges of the lower core element.

5. The inductive device of claim 1, wherein the plurality of flat coil windings are each formed from a conductive flat sheet of base material.

6. The inductive device of claim 5, wherein each of the plurality of self-bondable coil windings comprise a plurality of turns of a self-bondable wire arranged so as to have a substantially planar shape.

7. The inductive device of claim 6, wherein the self-bondable wire is coated with a jacketing material that provides one or more layers of insulation to the self- bondable wire.

8. The inductive device of claim 7, wherein the one or more layers of insulation is selected from the group consisting of: (1) a single layer of insulation; (2) a double layer of insulation; and (3) a triple layer of insulation.

9. The inductive device of claim 7, wherein the self-bondable wire comprises a plurality of strands of a conductive wire that is configured to carry current while simultaneously reducing the skin effect and proximity effect losses associated with a single stranded conductor.

10. The inductive device of claim 9, wherein the self-bondable wire further comprises an adhesive coating that is applied over the jacketing material, the adhesive coating configured to bond the plurality of turns of the self-bondable wire when heated.

11. The inductive device of claim 10, further comprises at least one insulation layer, the at least one insulation layer being disposed between adjacent ones of the flat coil windings and/or the self-bondable coil windings.

12. The inductive device of claim 1, wherein at least a portion of the plurality of terminals protrude from an upper surface of the header assembly at an angle of approximately 45° with respect to the upper surface.

13. The inductive device of claim 12, wherein the plurality of terminals comprises two groupings of terminals, the first grouping comprising the at least portion of the plurality of terminals that protrude from the upper surface of the header assembly at an angle of approximately 45° with respect to the upper surface; and
the second grouping comprises the remaining portion of the plurality of terminals that protrudes substantially orthogonal from the upper surface of the header assembly.

14. The inductive device of claim 13, wherein the plurality of flat coil windings are configured to terminate to the second grouping of terminals; and
wherein the plurality of self-bondable coil windings are configured to terminate to the first grouping of terminals.

15. A method of manufacturing an inductive device, comprising:
providing a header assembly;
providing one or more core elements;
providing a plurality of flat coil windings;
providing a plurality of self-bondable coil windings; and
assembling the plurality of flat coil windings, the plurality of self-bondable coil windings, and the one or more core elements to the header assembly.

16. The method of claim 15, wherein the act of assembling the plurality of flat coil windings, the plurality of self-bondable coil windings, and the one or more core elements to the header assembly further comprises interleaving the plurality of flat coil windings and the plurality of self-bondable coil windings.

17. The method of claim 16, further comprising:
providing one or more insulation layers; and
disposing the one or more insulation layers between adjacent ones of the plurality of flat coil windings and/or the plurality of self-bondable coil windings.

18. The method of claim 15, wherein the act of providing the plurality of self-bondable coil windings further comprises:
providing a wire strand;
winding the wire strand in a substantially planar shape having a plurality of turns; and
heating the wound wire strand so as to form at least one of the plurality of self-bondable coil windings.

19. The method of claim 18, wherein the header assembly further comprises a plurality of terminals that collectively comprises two groupings of terminals, the first grouping comprising a plurality of terminals that protrude from an upper surface of the header assembly at an angle of approximately 45° with respect to the upper surface; and
the second grouping comprises the remaining portion of the plurality of terminals that protrudes substantially orthogonal from the upper surface of the header assembly.

20. The inductive device of claim 19, further comprising:
bonding a plurality of ends of the flat coil windings to respective ones of the second grouping of terminals; and
bonding a plurality of ends of the self-bondable coil windings to respective ones of the first grouping of terminals.
